(19) United States
(12) Patent Application Publication
(10) Pub. No.: US 2012/0171561 A1
(43) Pub. Date: Jul. 5, 2012

(54) POLYMER RADICAL MATERIAL-ACTIVATED CARBON-CONDUCTIVE MATERIAL COMPOSITE, METHOD FOR PRODUCING CONDUCTIVE MATERIAL COMPOSITE, AND ELECTRICITY STORAGE DEVICE

(75) Inventors: Shigeyuki Iwasa, Tokyo (JP); Kentaro Nakahara, Tokyo (JP); Masahiro Suguro, Tokyo (JP); Motoharu Yasui, Tokyo (JP)

(73) Assignee: NEC CORPORATION, Minato-ku, Tokyo (JP)

(21) Appl. No.: 13/394,877

(22) PCT Filed: Aug. 16, 2010
(86) PCT No.: PCT/JP2010/066008

§ 371 Date: Mar. 8, 2012

(30) Foreign Application Priority Data
Sep. 18, 2009 (JP) 2009-216737

(51) Int. Cl. H01M 4/60; H01M 4/583; H01B 1/24; H01M 4/64; H01M 10/02; B82Y 30/00

(52) U.S. Cl. 429/188; 429/213; 252/511; 977/742; 977/948

(57) ABSTRACT

The object of the present invention is to provide an electrode material which enables the production of an electricity storage device that has a large discharge capacity, and suffers minimal voltage drop due to resistance even when discharge is performed at a large electric current; a method for producing the electrode material; and an electricity storage device that exhibits both high energy density and high output characteristics, and an electricity storage device is produced which uses, as an electrode, a polymer radical material-activated carbon-conductive material composite, prepared by adding dropwise, or pouring, a raw material solution, in which a polymer radical material having a radical partial structure in a reduced state is dissolved or swollen and an activated carbon and a conductive material are dispersed or dissolved, into a solution in which the polymer radical material, the activated carbon and the conductive material do not dissolve or swell, thus obtaining a precipitate containing the polymer radical material, the activated carbon and the conductive material.

### TECHNICAL FIELD

The present invention relates to a polymer radical material-activated carbon-conductive material composite, a method for producing a conductive material composite, and an electricity storage device.

### BACKGROUND ART

In recent years, as communication systems have developed, portable electronic devices such as notebook computers and mobile telephones have spread rapidly. Moreover, the appearance of new portable electronic devices such as portable electronic papers can also be expected. The electricity storage devices that act as the power sources for these portable electronic devices require a high degree of energy density in order to enable extended use.

However, with the ongoing development and diversification of portable electronic devices, the electricity storage devices used as power sources require not only a high energy density, but also all manner of other properties. One example of another required property is a large output density.

Furthermore, with global warming and environmental issues become increasingly serious, the development of electric vehicles and hybrid vehicles as clean alternatives to gasoline-based vehicles is thriving. The electricity storage devices used in these types of applications require not only a high energy density, but also large output characteristics.

One example of a known electricity storage device that exhibits a large output is the electric double layer capacitor. This type of electric double layer capacitor uses activated carbon for both electrodes, can discharge a large electric current at a single time, and can discharge electricity with an extremely large output. Further, electric double layer capacitors also exhibit excellent cycle characteristics, and are also being developed as backup power sources and the like. However, the energy density of electric double layer capacitors is extremely small.

Electricity storage devices that use activated carbon for the positive electrode in a similar manner to an electric double layer capacitor, but use a carbon that is capable of lithium ion insertion and elimination reactions as the negative electrode in a similar manner to a lithium ion battery are also being developed. These devices are known as lithium ion capacitors, and because they store an electric charge via an electrostatic mechanism that uses an electric double layer, the output density is very high in a similar manner to that observed for electric double layer capacitors, and the cycle stability is also very high. Moreover, the energy density is approximately 4- to 5-fold larger than that of electric double layer capacitors. However, compared with the negative electrode, the energy density of the positive electrode is low, and therefore achieving a capacity balance between the positive electrode and the negative electrode is difficult, and a technique in which the negative electrode is pre-doped with lithium ions using either a chemical method or an electrochemical method is required (for example, see Patent Document 1).

On the other hand, batteries that use a polymer radical compound for the electrode active material are also being developed for the purpose of obtaining a lightweight electrode material. These batteries are known as organic radical batteries. Patent Document 3 proposes a rechargeable battery in which the active material of at least one of the positive electrode and the negative electrode includes a radical compound. Further, Patent Documents 2, 3 and 4 all propose electricity storage devices in which the positive electrode contains a nitroxyl compound. In electricity storage devices such as these rechargeable batteries, because the electrode reaction for the electrode active material (radical compound) is itself very rapid, charging and discharging can be performed at a large electric current, meaning the rechargeable batteries are capable of achieving a large output. Further, the variation in voltage during discharge is small.

Furthermore, electricity storage devices that represent a combination of an organic radical battery and a lithium ion capacitor have also been proposed (see Patent Document 5). This device uses a mixture of a radical compound and an activated carbon for the positive electrode. In this electricity storage device, in a short discharge of approximately 1 second, the activated carbon mainly functions as the active material, meaning an extremely large output similar to that of an electric double layer capacitor can be obtained. However, in the case of a longer discharge, the polymer radical material functions as the active material, resulting in high output characteristics similar to those of an organic radical battery. Moreover, the voltage drop during discharge is smaller than that observed for lithium ion capacitors.

Patent Document 5 proposes an electricity storage device that uses a polymer radical material and an activated carbon for the positive electrode or the like. However, the polymer radical material that is included is an aliphatic organic compound, and therefore lacks any conductivity itself. In order to enable the radical compound within the electrode to participate in the charging and discharging, a conductive material that is capable of efficiently transferring electrons to and from the polymer radical material must be mixed with the polymer radical material.

### PRIOR ART DOCUMENTS

### Patent Documents

### Patent Document 1

Japanese Unexamined Patent Application, First Publication No. Hei 08-107048

### Patent Document 2

Japanese Patent (Granted) Publication No. 3,687,736

### Patent Document 3

Japanese Unexamined Patent Application, First Publication No. 2002-304996

### Patent Document 4

Japanese Unexamined Patent Application, First Publication No. 2007-165054

### Patent Document 5

Japanese Unpublished Patent Application No. 2008-046610

### DISCLOSURE OF INVENTION

### Problems to be Solved by the Invention

However, even if a polymer radical material, an activated carbon and a conductive material are mixed together for use in an electrode, achieving a uniform distribution of these component materials is difficult, and as a result, the discharge capacity tends to decrease and achieving discharge at a large electric current becomes problematic.

The present invention has been developed in light of the above circumstances, and has an object of providing a composite that can be used for producing an electricity storage device that has a large discharge capacity and suffers minimal voltage drop due to resistance even when discharge is performed at a large electric current, as well as providing a method for producing such a composite. Further, another object of the invention is to provide an electricity storage device that exhibits both high energy density and high output characteristics.

### Means to Solve the Problems

A method for producing a polymer radical material-activated carbon-conductive material composite according to the present invention includes adding dropwise, or pouring, a raw material solution, in which a polymer radical material having a radical partial structure in a reduced state is dissolved or swollen and an activated carbon and a conductive material are dispersed or dissolved, into a solution in which the polymer radical material, the activated carbon and the conductive material do not dissolve or swell, thereby producing a precipitate containing the polymer radical material, the activated carbon and the conductive material.

In a preferred aspect of the method for producing a polymer radical material-activated carbon-conductive material composite according to the present invention, the polymer radical material is a nitroxyl polymer compound having a nitroxyl cation partial structure represented by chemical formula (1) shown below in an oxidized state, and having a nitroxyl radical partial structure represented by chemical formula (2) shown below in a reduced state.

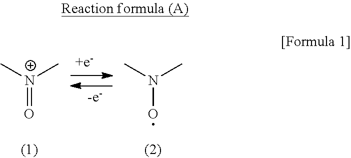

In another preferred aspect of the method for producing a polymer radical material-activated carbon-conductive material composite according to the present invention, the nitroxyl polymer compound described above is a polymer compound containing a cyclic nitroxyl structure represented by chemical formula (3) shown below in a reduced state.

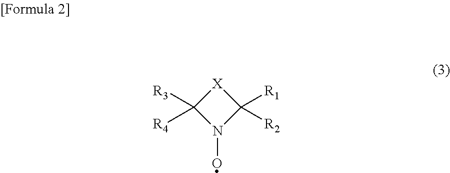

In chemical formula (3), each of R₁ to R₄ independently represents an alkyl group, and X represents a divalent group that results in the formation of a 5- to 7-membered ring within the chemical formula (3), provided that at least a portion of X constitutes a portion of the main chain of the polymer.

In yet another preferred aspect of the method for producing a polymer radical material-activated carbon-conductive material composite according to the present invention, the polymer radical material is a polymer compound having a chemical structure represented by chemical formula (4) and/or chemical formula (5) shown below, or a copolymer that includes the chemical structure as a repeating unit.

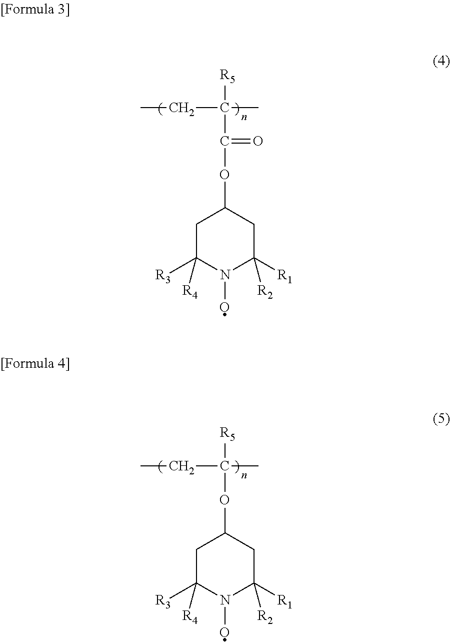

In chemical formulas (4) and (5), each of R₁ to R₄ independently represents an alkyl group, and R₅ represents a hydrogen atom or a methyl group.

A polymer radical material-activated carbon-conductive material composite of the present invention capable of achieving the object described above is prepared by adding dropwise, or pouring, a raw material solution, in which a polymer radical material having a radical partial structure in a reduced state is dissolved or swollen and an activated carbon and a conductive material are dispersed or dissolved, into a solution in which the polymer radical material, the activated carbon and the conductive material do not dissolve or swell, thus obtaining a precipitate in which the activated carbon and the conductive material are incorporated within the interior of the polymer radical material.

In a preferred aspect of the polymer radical material-activated carbon-conductive material composite according to the present invention, the polymer radical material is a nitroxyl polymer compound having a nitroxyl cation partial structure represented by chemical formula (1) shown below in an oxidized state, and having a nitroxyl radical partial structure represented by chemical formula (2) shown below in a reduced state.

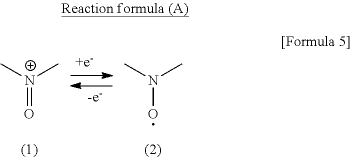

In another preferred aspect of the polymer radical material-activated carbon-conductive material composite according to the present invention, the nitroxyl polymer compound described above is a polymer compound containing a cyclic nitroxyl structure represented by chemical formula (3) shown below in a reduced state.

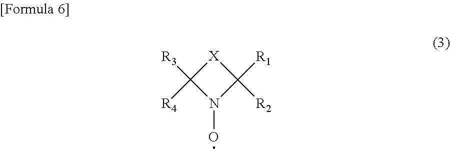

In chemical formula (3), each of R₁ to R₄ independently represents an alkyl group, and X represents a divalent group that results in the formation of a 5- to 7-membered ring within the chemical formula (3), provided that at least a portion of X constitutes a portion of the main chain of the polymer.

In yet another preferred aspect of the polymer radical material-activated carbon-conductive material composite according to the present invention, the polymer radical material is a polymer compound having a chemical structure represented by chemical formula (4) and/or chemical formula (5) shown below, or a copolymer that includes the chemical structure as a repeating unit.

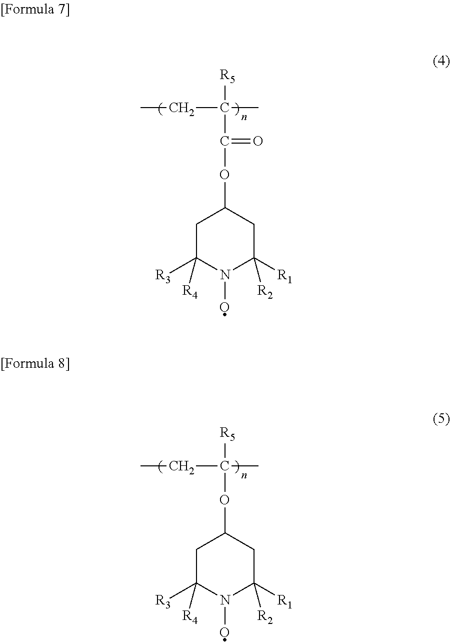

In chemical formulas (4) and (5), each of R₁ to R₄ independently represents an alkyl group, and R₅ represents a hydrogen atom or a methyl group.

In yet another preferred aspect of the polymer radical material-activated carbon-conductive material composite according to the present invention, the conductive material is at least one material selected from the group consisting of natural graphite, artificial graphite, carbon black, vapor-grown carbon fiber, mesophase pitch carbon fiber, and carbon nanotubes.

In yet another preferred aspect of the polymer radical material-activated carbon-conductive material composite according to the present invention, the activated carbon is in a particulate form and has a specific surface area of at least 1,000 m²/g.

In yet another preferred aspect of the polymer radical material-activated carbon-conductive material composite according to the present invention, the activated carbon is in a particulate form, and is at least one activated carbon selected from the group consisting of phenolic resin-based activated carbon, petroleum pitch-based activated carbon, petroleum coke-based activated carbon, and coal coke-based activated carbon.

An electricity storage device of the present invention capable of achieving the object described above is a device that uses the polymer radical material-activated carbon-conductive material composite described above as an electrode.

An electricity storage device of the present invention capable of achieving the object described above is a device which uses, as an electrode, a mixture of an activated carbon, and a polymer radical material-conductive material composite that is prepared by adding dropwise, or pouring, a raw material solution, in which a polymer radical material having a radical partial structure in a reduced state is dissolved or swollen and a conductive material is dispersed or dissolved, into a solution in which the polymer radical material and the conductive material do not dissolve or swell, thus obtaining a precipitate containing the polymer radical material and the conductive material.

In a preferred aspect of the electricity storage device according to the present invention, the polymer radical material is a nitroxyl polymer compound having a nitroxyl cation partial structure represented by chemical formula (1) shown below in an oxidized state, and having a nitroxyl radical partial structure represented by chemical formula (2) shown below in a reduced state.

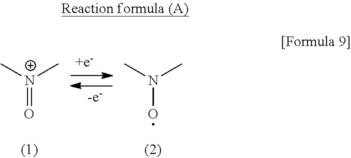

In another preferred aspect of the electricity storage device according to the present invention, the nitroxyl polymer compound described above is a polymer compound containing a cyclic nitroxyl structure represented by chemical formula (3) shown below in a reduced state.

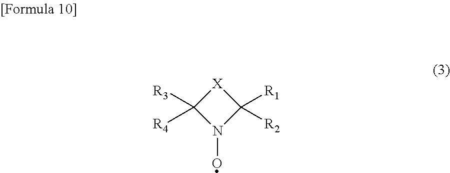

In chemical formula (3), each of R₁ to R₄ independently represents an alkyl group, and X represents a divalent group that results in the formation of a 5- to 7-membered ring within the chemical formula (3), provided that at least a portion of X constitutes a portion of the main chain of the polymer.

In yet another preferred aspect of the electricity storage device according to the present invention, the polymer radical material is a polymer compound having a chemical structure represented by chemical formula (4) and/or chemical formula (5) shown below, or a copolymer that includes the chemical structure as a repeating unit.

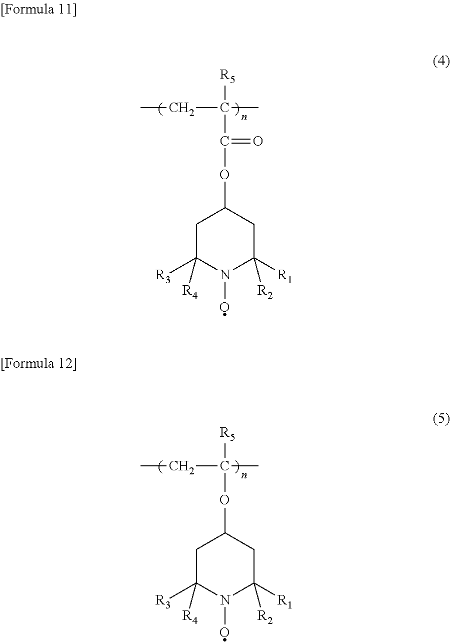

In chemical formulas (4) and (5), each of R₁ to R₄ independently represents an alkyl group, and R₅ represents a hydrogen atom or a methyl group.

In yet another preferred aspect of the electricity storage device according to the present invention, the electrode described above is a positive electrode.

In yet another preferred aspect of the electricity storage device according to the present invention, the electrode described above is a positive electrode, the negative electrode contains a material that can reversibly support lithium ions, and an aprotic organic solvent containing a lithium salt is used for the electrolyte.

In yet another preferred aspect of the electricity storage device according to the present invention, the electricity storage device further includes a lithium ion supply source, the positive electrode and/or the negative electrode includes a current collector having holes that penetrate through the front and rear surfaces of the current collector, and the current collector is pre-doped with lithium ions via an electrochemical contact between the negative electrode and the lithium ion supply source.

### Effect of the Invention

The method for producing a polymer radical material-activated carbon-conductive material composite according to the present invention enables the production of a polymer radical material-activated carbon-conductive material composite having superior electron conductivity.

The polymer radical material-activated carbon-conductive material composite of the present invention is able to impart favorable electron conductivity.

According to the electricity storage device of the present invention, the discharge capacity can be increased, charging and discharging at a large electric current is possible, and a large electric current can be discharged for several seconds.

### BRIEF DESCRIPTION OF THE DRAWINGS

FIG. 1 is a schematic cross-sectional view of one example of an electricity storage device.

FIG. 2 is a schematic cross-sectional view of another example of an electricity storage device.

FIG. 3 is an electron microscope photograph of a nitroxyl polymer compound-activated carbon-carbon material composite.

FIG. 4 is an electron microscope photograph of a nitroxyl polymer compound-carbon material composite.

### BEST MODE FOR CARRYING OUT THE INVENTION

A more detailed description of the present invention is presented below, but the present invention is in no way limited by the following description, and many arbitrary modifications are possible without departing from the scope of the present invention.

### [Method for Producing Polymer Radical Material-Activated Carbon-Conductive Material Composite]

A method for producing a polymer radical material-activated carbon-conductive material composite according to the present invention includes adding dropwise, or pouring, a raw material solution, in which a polymer radical material having a radical partial structure in a reduced state is dissolved or swollen and an activated carbon and a conductive material are dispersed or dissolved, into a solution in which the polymer radical material, the activated carbon and the conductive material do not dissolve or swell, thereby producing a precipitate containing the polymer radical material, the activated carbon and the conductive material.

In the present invention, the specific method according to the aspect of the present invention described above enables the production of a composite using a polymer radical material and an activated carbon, in which the polymer radical material, the activated carbon and a conductive material are distributed uniformly through the composite. Accordingly, the obtained polymer radical material-activated carbon-conductive material composite can be imparted with favorable electron conductivity. As a result, in an electrode produced from the polymer radical material-activated carbon-conductive material composite, the proportion of the electrode that is able to participate in oxidation-reduction of the radical site of the polymer radical material increases.

For this reason, an electrode produced using the polymer radical material-activated carbon-conductive material composite exhibits a greater discharge capacity than an electrode obtained by simply mixing the polymer radical material, the activated carbon and the conductive material. Further, in the electrode that uses the polymer radical material-activated carbon-conductive material composite, because the transfer of electrons that accompanies the oxidation and reduction of the polymer radical material can occur smoothly via the conductive material, charging and discharging at a large electric current is possible. Furthermore, a large electric current can be discharged for several seconds.

Each of the structural components is described below in further detail.

### (Polymer Radical Material)

First is a description of the polymer radical material. A material that can be used as an electricity storage device and has a radical partial structure in a reduced state may be used as the polymer radical material. More specifically, as illustrated in the reaction formula (A) below, a nitroxyl polymer compound having a nitroxyl cation partial structure represented by chemical formula (1) in an oxidized state, and having a nitroxyl radical partial structure represented by chemical formula (2) in a reduced state can be used favorably.

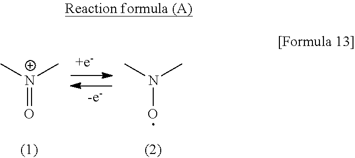

The reaction formula (A) represents the electrode reaction at the positive electrode, and a polymer radical material that undergoes this type of reaction can be used as a material for an electricity storage device capable of storing and discharging electrons. The oxidation-reduction reaction of the reaction formula (A) represents a reaction mechanism that is not accompanied by a structural change in the organic compound, and therefore the reaction rate is large, and if an electricity storage device is constructed using this polymer radical material as an electrode material, then a large electric current can be discharged at a single time.

In the present invention, the nitroxyl polymer compound is preferably a polymer compound containing a cyclic nitroxyl structure represented by chemical formula (3) shown below in a reduced state.

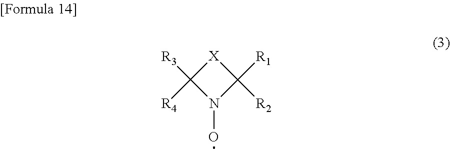

In chemical formula (3), each of R₁ to R₄ independently represents an alkyl group, and each group preferably independently represents a linear alkyl group. Further, from the viewpoint of radical stability, each of R₁ to R₄ preferably independently represents an alkyl group of 1 to 4 carbon atoms, and a methyl group is particularly desirable.

X represents a divalent group that results in the formation of a 5- to 7-membered ring within the chemical formula (3), provided that at least a portion of X constitutes a portion of the main chain of the polymer. There are no particular limitations on the structure of X, which typically includes elements selected from among carbon, oxygen, nitrogen and sulfur.

There are no particular limitations on X, provided it represents a divalent group that results in the formation of a 5- to 7-membered ring within the chemical formula (3). Specific examples include —CH₂CH₂—, —CH₂CH₂CH₂—, —CH₂CH₂CH₂CH₂—, —CH═CH—, —CH═CHCH₂— —CH═CHCH₂CH₂— and —CH₂CH═CHCH₂—, wherein non-adjacent —CH₂-moieties may be substituted with —O—, —NH— or —S—, and —CH═ may be substituted with —N═. Further, the hydrogen atoms bonded to the atoms that constitute the ring may be substituted with an alkyl group, halogen atom or ═O or the like.

Of the various possibilities, a particularly preferred cyclic nitroxyl structure, in its reduced state, is selected from the group consisting of a 2,2,6,6-tetramethylpiperidinoxyl radical represented by chemical formula (6), a 2,2,5,5-tetramethylpyrrolidinoxyl radical represented by chemical formula (7) and a 2,2,5,5-tetramethylpyrrolinoxyl radical represented by chemical formula (8). In chemical formulas (6) to (8), R₁ to R₄ are as defined above for chemical formula (3).

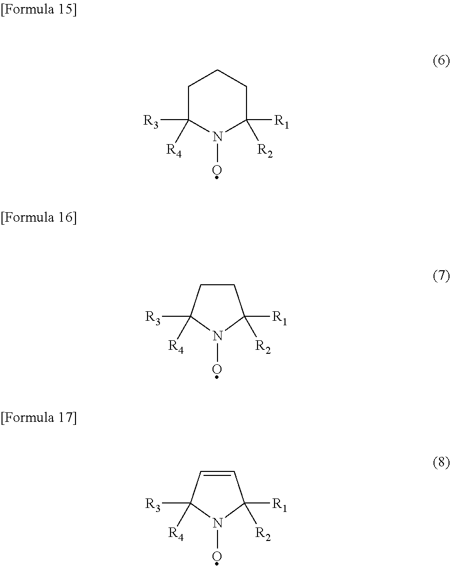

In the present invention, the cyclic nitroxyl structure represented by the above chemical formula (3) constitutes a portion of a side chain or the main chain of a polymer. In other words, at least a portion of X constitutes a portion of the main chain of the polymer, and the cyclic nitroxyl structure exists within a portion of the side chain or main chain of the polymer in the form of a structure in which at least one hydrogen atom bonded to an element that constitutes the cyclic structure has been removed. In terms of ease of synthesis and the like, the cyclic nitroxyl structure preferably exists within a side chain. When the cyclic nitroxyl structure exists within a side chain, then as illustrated below in chemical formula (9), the cyclic structure is bonded to the main chain polymer via a residue X′, which is obtained by removing a hydrogen atom from a —CH₂—, —CH═ or —NH— moiety that represents a member of the group X that constitutes the ring of the cyclic nitroxyl structure shown in chemical formula (3).

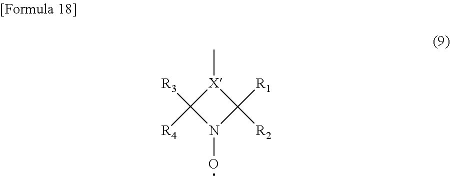

In chemical formula (9), R₁ to R₄ are the same as defined above in chemical formula (3), and X′ represents a residue obtained by removing a hydrogen atom from X in chemical formula (3). In this case, there are no particular limitations on the structure of the main chain polymer, and any structure is suitable provided the residue represented by chemical formula (9) exists within a side chain. Specific examples include polymers in which a residue represented by chemical formula (9) is added to one of the polymers mentioned below, or polymers in which a portion of atoms or groups within one of the polymers mentioned below is substituted with a residue represented by chemical formula (9). In either case, the residue represented by chemical formula (9) need not necessarily be bonded directly to the polymer chain, and may also be bonded via an appropriate divalent group.

Examples of the main chain polymer include polyalkylene polymers such as polyethylene, polypropylene, polybutene, polydecene, polydodecene, polyheptene, polyisobutene and polyoctadecene, diene polymers such as polybutadiene, polychloroprene, polyisoprene and polyisobutene, poly(meth)acrylic acid, poly(meth)acrylonitrile, poly(meth)acrylamide polymers such as poly(meth)acrylamide, poly(methyl(meth)acrylamide), poly(dimethyl(meth)acrylamide) and poly(isopropyl (meth)acrylamide), poly(alkyl(meth)acrylates) such as poly(methyl(meth)acrylate), poly(ethyl(meth)acrylate) and poly(butyl(meth)acrylate), fluorine-based polymers such as polyvinylidene fluoride and polytetrafluoroethylene, polystyrene polymers such as polystyrene, polybromostyrene, polychlorostyrene and polymethylstyrene, vinyl polymers such as polyvinyl acetate, polyvinyl alcohol, polyvinyl chloride, poly(vinyl methyl ether), polyvinyl carbazole, polyvinyl pyridine and polyvinylpyrrolidone, polyether polymers such as polyethylene oxide, polypropylene oxide, polybutene oxide, polyoxymethylene, polyacetaldehyde, poly(methyl vinyl ether), poly(propyl vinyl ether), poly(butyl vinyl ether) and poly(benzyl vinyl ether), polysulfide polymers such as polymethylene sulfide, polyethylene sulfide, polyethylene disulfide, polypropylene sulfide, polyphenylene sulfide, polyethylene tetrasulfide and polyethylene trimethylene sulfide, polyesters such as polyethylene terephthalate, polyethylene adipate, polyethylene isophthalate, polyethylene naphthalate, polyethylene paraphenylene diacetate and polyethylene isopropylidene dibenzoate, polyurethanes such as poly(trimethylene ethylene urethane), polyketone polymers such as polyetherketone and poly(allyl ether ketone), polyanhydride polymers such as polyoxyisophthaloyl, polyamine polymers such as polyethylene amine, polyhexamethylene amine and polyethylene trimethylene amine, polyamide polymers such as nylon, polyglycine and polyalanine, polyimine polymers such as poly(acetyliminoethylene) and poly(benzoyliminoethylene), polyimide polymers such as polyesterimide, polyetherimide, polybenzimide and polypyrromelimide, polyaromatic polymers such as polyarylene, polyarylene alkylene, polyarylene alkenylene, polyphenol, phenolic resin, cellulose, polybenzimidazole, polybenzothiazole, polybenzoxazine, polybenzoxazole, polycarborane, polydibenzofuran, polyoxoisoindoline, polyfuran tetracarboxylic diimide, polyoxadiazole, polyoxindole, polyphthalazine, polyphthalide, polycyanurate, polyisocyanurate, polypiperazine, polypiperidine, polypyrazinoquinoxane, polypyrazole, polypyridazine, polypyridine, polypyromellitimine, polyquinone, polypyrrolidine, polyquinoxaline, polytriazine and polytriazole, siloxane polymers such as polydisiloxane and polydimethylsiloxane, polysilane polymers, polysilazane polymers, polyphosphazene polymers, polythiazyl polymers, and conjugated polymers such as polyacetylene, polypyrrole and polyaniline. The term “(meth)acryl” means either methacryl or acryl.

Among these, in terms of achieving superior electrochemical resistance, the polymer preferably includes a polyalkylene polymer, poly(meth)acrylic acid, poly(meth)acrylamide polymer, poly(alkyl(meth)acrylate) or polystyrene polymer as a main chain structure. The main chain refers to the carbon chain having the largest number of carbon atoms within the polymer compound. The polymer is preferably selected from among the above polymers so as to be capable of including a unit represented by chemical formula (10) shown below in a reduced state.

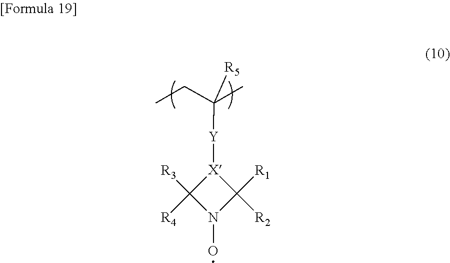

In chemical formula (10), R₁ to R₄ are the same as defined above for chemical formula (3), and X′ is the same as defined above for chemical formula (9). R₅ represents a hydrogen atom or a methyl group. There are no particular limitations on Y, and examples include —CO—, —COO—, —CONR₆—, —O—, —S—, alkylene groups of 1 to 18 carbon atoms which may have a substituent, arylene groups of 1 to 18 carbon atoms which may have a substituent, and divalent groups composed of a combination of two or more of the above groups. R₆ represents an alkyl group of 1 to 18 carbon atoms. Among the units represented by chemical formula (10), units represented by chemical formulas (11) to (13) shown below are particularly desirable.

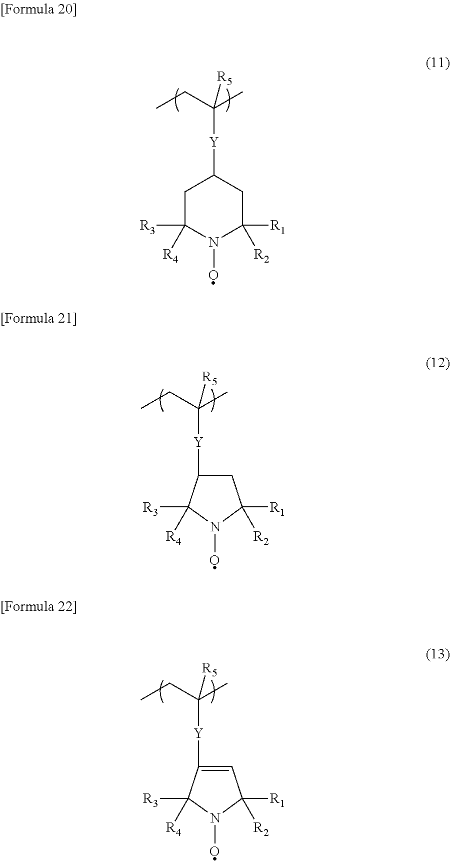

In chemical formulas (11) to (13), R₁ to R₄ are the same as defined above for chemical formula (3), and Y is the same as defined above for chemical formula (10), but is preferably —COO—, —O— or —CONR₆—.

In the present invention, the residue represented by chemical formula (9) need not necessarily exist in all of the side chains. For example, either all of the units that constitute the polymer may be represented by chemical formula (10), or only a portion of the units may be represented by chemical formula (10). The amount of the residue incorporated within the polymer differs depending upon the purpose, the polymer structure and the production method employed. The residue may exist in only a small amount, but typically represents at least 1% by weight, and preferably at least 10% by weight, of the polymer. There are no particular limitations on the amount of the residue included when synthesizing the polymer, and in those cases where a large storage action is required, the amount of the residue preferably represents at least 50% by weight, and more preferably 80% by weight or more of the polymer.

Examples of the units within a nitroxyl polymer that can be used favorably in the present invention include polymer compounds having a chemical structure represented by the chemical formulas (4) and/or (5) shown below, or copolymers that include one or more of these chemical structures as a repeating unit. In chemical formulas (4) and (5), R₁ to R₄ are the same as defined above for chemical formula (3), and R₅ represents a hydrogen atom or a methyl group.

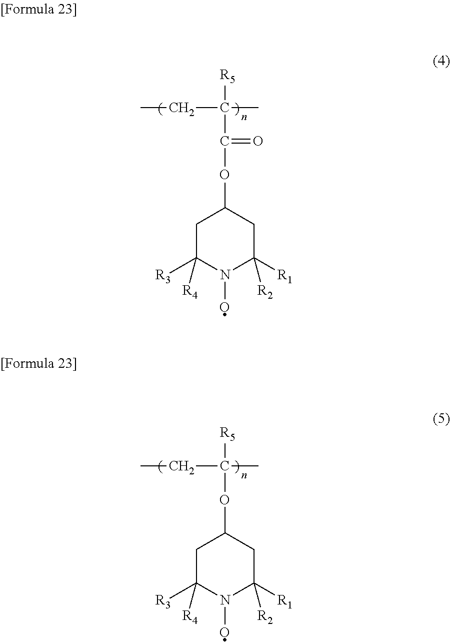

There no particular limitations on the molecular weight of the nitroxyl polymer in the present invention, but the molecular weight is preferably large enough to prevent dissolution in the electrolyte upon construction of an electricity storage device, and this value varies depending on the combination with the type of organic solvent used in the electrolyte. Generally, the weight-average molecular weight of the nitroxyl polymer is at least 1,000, preferably at least 10,000, and more preferably 20,000 or greater. Moreover, the weight-average molecular weight is typically not more than 5,000,000, and preferably not more than 500,000. Further, a polymer containing a residue represented by chemical formula (9) may be cross-linked, and such cross-linking can improve the durability of the polymer relative to electrolytes.

### (Activated Carbon)

Activated carbon describes an amorphous carbon composed mostly of carbon matter that exhibits very high adsorptivity. There are no particular limitations on the activated carbon used in the present invention, which is typically obtained by a method in which a raw material such as a phenolic resin, petroleum pitch, petroleum coke, coconut husk, or coal coke is fired and carbonized in an inert gas atmosphere of nitrogen gas or argon gas or the like, and the resulting material is then subjected to an activation treatment using water vapor or an alkali activator.

Although are no particular limitations on the activated carbon used in the present invention, in order to ensure a satisfactory specific surface area, the activated carbon is preferably in particulate form, and is preferably at least one material selected from the group consisting of phenolic resin-based activated carbon, petroleum pitch-based activated carbon, petroleum coke-based activated carbon, and coal coke-based activated carbon. There are no particular limitations on the particle size of the activated carbon, but usually an activated carbon having a fine particle size is used. For example, the 50% cumulative volume particle size (also referred to as D50) is typically at least 2 μm, preferably within a range from 2 to 50 μm, and most preferably from 2 to 20 μm. Moreover, the average pore size of the activated carbon is preferably not more than 10 nm. In the present embodiment, the average particle size refers to the D50 within a particle size distribution measured using a laser diffraction-type particle size distribution analyzer.

The activated carbon is preferably in particulate form, and preferably has a specific surface area of at least 1,000 m²/g. The specific surface area can be measured, for example, using the BET method.

### (Conductive Material)

Next is a description of the conductive material. Various fine particulate materials, powdered materials, fiber-like materials or tube-like materials can be used as the conductive material, provided they have sufficient conductivity that when incorporated within the interior of the polymer radical material described above, they are able to impart the composite with favorable electron conductivity. Examples of the conductive material include carbon materials, conductive inorganic materials and conductive polymer materials. Among these, carbon materials are preferred, and specifically, at least one material selected from the group consisting of natural graphite, artificial graphite, carbon black, vapor-grown carbon fiber, mesophase pitch carbon fiber, and carbon nanotubes is particularly desirable. Two or more of these conductive materials may also be mixed in any arbitrary ratio, provided the mixture remains within the scope of the present invention.

There are no particular limitations on the size of the conductive material, but from the viewpoint of achieving uniform dispersion, the finer the material is the better, and in the case of a fine particulate material, the average primary particle size is preferably not more than 500 nm, whereas in the case of fiber-like or tube-like materials, the diameter is preferably not more than 500 nm, and the length is preferably at least 5 nm but not more than 50 μm. The average particle size and dimensions mentioned above refer to average values obtained by electron microscope observation, or to D50 values of a particle size distribution measured using a laser diffraction-type particle size distribution analyzer.

As described below in the section relating to the production method, these conductive materials may or may not dissolve in the solvent used in foaming the raw material solution, but the polymer radical material, the activated carbon and the conductive material within this raw material solution must neither dissolve nor swell in the solution used for producing the precipitate product. Typically, the activated carbon, and carbon materials or inorganic materials having good conductivity dissolve in neither the raw material solution nor the solution used for producing the precipitate, and most of these materials are dispersed within the solutions.

### (Production Method)

The method for producing a polymer radical material-activated carbon-conductive material composite according to the present invention includes adding dropwise, or pouring, a raw material solution, in which a polymer radical material having a radical partial structure in a reduced state is dissolved or swollen and an activated carbon and a conductive material are dispersed or dissolved, into a solution in which the polymer radical material, the activated carbon and the conductive material do not dissolve or swell, thereby producing a precipitate containing the polymer radical material, the activated carbon and the conductive material.

The polymer radical material, the activated carbon and the conductive material are as described above, and therefore the following description details other facets of the production method.

The solvent used in forming the raw material solution for the polymer radical material-activated carbon-conductive material composite must be a solvent that is capable of dissolving or swelling the polymer radical material described above. This solvent need not necessarily be capable of dissolving the activated carbon and the conductive material, and in most cases, activated carbons and carbon materials or inorganic materials having good conductivity are insoluble in solvents, and are therefore dispersed rather than dissolved in the solvent. A preferred example of this type of solvent is N-methylpyrrolidone, but other solvents that exhibit the type of dissolution properties described above can also be used favorably.

Preparation of the raw material solution is usually performed by first dissolving the polymer radical material in a solvent capable of dissolving or swelling the polymer radical material, and then adding the activated carbon and conductive material and stirring.

The amount added of the conductive material may be adjusted with due consideration of the electron conductivity and the like, but is typically within a range from not less than 5 parts by weight to not more than 200 parts by weight per 100 parts by weight of the polymer radical material. Provided the amount is within this range, the conductivity of the resulting electrode tends to be satisfactory, while any relative decrease in the amount of the polymer radical material is suppressed, enabling the capacity of the battery to be better maintained.

The amount added of the activated carbon is typically within a range from not less than 5 parts by weight to not more than 500 parts by weight per 100 parts by weight of the polymer radical material. Provided the amount is within this range, satisfactory output characteristics can be more easily achieved, while any relative decrease in the amount of the polymer radical material is suppressed, enabling the capacity of the battery to be better maintained.

In the present description, the expression that the polymer radical material “dissolves” includes not only the case where the material literally dissolves, but also cases where the material develops fluidity and becomes compatible with the solvent. Further, the expression “swells” describes a state in which the polymer radical material, although not undergoing typical dissolution, interacts with the solvent to generate a so-called swollen state, so that when the swollen solution is mixed with the conductive material, the conductive material is able to be dispersed uniformly within the polymer radical material. Further, the “dispersion” of the conductive material describes the state where an insoluble material such as a carbon material is dispersed within the solvent, whereas “dissolving” the conductive material includes not only the case where the conductive material literally dissolves, but also cases where the material is compatible with the solvent.

Examples of devices that can be used for mixing the polymer radical material, the activated carbon and the conductive material include stirring and mixing devices such as a homogenizer. By mixing the materials using this type of device, a slurry-like raw material solution is obtained in which the conductive material is dispersed uniformly within a solution in which the polymer radical material has been dissolved or swollen.

The raw material solution obtained in this manner is either added gradually in a dropwise manner, or poured into, a solvent (a poor solvent) such as methanol in which the polymer radical material, the activated carbon and the conductive material do not dissolve. As a result, the polymer radical material, the activated carbon and the conductive material can be precipitated simultaneously.

The poor solvent is selected mainly based on its relationship with the polymer radical material, and although methanol or the like can usually be used favorably in the present invention, other solvents may also be used, provided they function as poor solvents. The activated carbon and the conductive material generally exhibit poor solubility in organic solvents and therefore need not be given much consideration when selecting the poor solvent, but the poor solvent must not be capable of dissolving or swelling the activated carbon and/or the conductive material.

The raw material solution is either added dropwise or poured into the poor solvent to produce a precipitate, and the conditions of the dropwise addition or pouring (such as the drop volume or the dripping rate or the like) can be adjusted in accordance with the characteristics and form of the generated precipitate. In particular, in the present invention it is desirable that a precipitate is obtained in which the activated carbon and the conductive material are dispersed uniformly within the interior of the polymer radical material, and therefore the dropwise addition or pouring of the raw material solution is preferably conducted so as to achieve such a precipitate.

The obtained precipitate is collected by filtration or the like, and subsequent drying of the precipitate yields the polymer radical material-activated carbon-conductive material composite. The thus obtained polymer radical material-activated carbon-conductive material composite may be converted to a fine powder by crushing or the like.

As described above, the method for producing a polymer radical material-activated carbon-conductive material composite according to the present invention enables the activated carbon and the conductive material to be dispersed uniformly within the polymer radical material. The composite produced using this production method is obtained as a precipitate in which the activated carbon and the conductive material are incorporated within the interior of the polymer radical material, and therefore the composite can be imparted with favorable electron conductivity.

### [Method for Producing Polymer Radical Material-Conductive Material Composite]

A polymer radical material-conductive material composite can be obtained using a similar production method to the method for producing a polymer radical material-activated carbon-conductive material composite of the present invention described above. In other words, the method for producing a polymer radical material-conductive material composite includes adding dropwise, or pouring, a raw material solution, in which a polymer radical material having a radical partial structure in a reduced state is dissolved or swollen and a conductive material is dispersed or dissolved, into a solution in which the polymer radical material and the conductive material do not dissolve or swell, thereby producing a precipitate containing the polymer radical material and the conductive material.

Each of the elements such as the polymer radical material, the conductive material and the production method used in the method for producing the polymer radical material-conductive material composite may simply employ the same elements as those described above in the “method for producing a polymer radical material-activated carbon-conductive material composite”. In order to avoid repetition, description of these elements is omitted here.

According to this production method, a polymer radical material-conductive material composite is obtained as a precipitate in which the conductive material is incorporated within the interior of the polymer radical material. More specifically, the method for producing a polymer radical material-conductive material composite described above enables the conductive material to be dispersed uniformly within the polymer radical material. The composite obtained produced using this production method is obtained as a precipitate in which the conductive material is incorporated within the interior of the polymer radical material, and therefore the composite can be imparted with favorable electron conductivity.

### [Polymer Radical Material-Activated Carbon-Conductive Material Composite]

A polymer radical material-activated carbon-conductive material composite of the present invention is prepared by adding dropwise, or pouring, a raw material solution, in which a polymer radical material having a radical partial structure in a reduced state is dissolved or swollen and an activated carbon and a conductive material are dispersed or dissolved, into a solution in which the polymer radical material, the activated carbon and the conductive material do not dissolve or swell, and is obtained as a precipitate in which the activated carbon and the conductive material are incorporated within the interior of the polymer radical material.

In the polymer radical material-activated carbon-conductive material composite of the present invention, the polymer radical material, the activated carbon and the conductive material can be distributed uniformly. Accordingly, the resulting polymer radical material-activated carbon-conductive material composite can be imparted with favorable electron conductivity. As a result, in an electrode produced from the polymer radical material-activated carbon-conductive material composite, the proportion of the electrode that is able to participate in oxidation-reduction of the radical site of the polymer radical material increases.

For this reason, an electrode produced using the polymer radical material-activated carbon-conductive material composite exhibits a greater discharge capacity than an electrode obtained by simply mixing the polymer radical material, the activated carbon and the conductive material. Further, in the electrode that uses the polymer radical material-activated carbon-conductive material composite, because the transfer of electrons that accompanies the oxidation and reduction of the polymer radical material can occur smoothly via the conductive material, charging and discharging at a large electric current is possible. Furthermore, a large electric current can be discharged for several seconds.

Each of the elements such as the polymer radical material, the activated carbon, the conductive material and the production method used in the polymer radical material-conductive material composite may simply employ the same elements as those described above in the “method for producing a polymer radical material-activated carbon-conductive material composite”. Accordingly, in order to avoid repetition, description of these elements is omitted here.

### [Electricity Storage Device]

A first electricity storage device of the present invention uses the polymer radical material-activated carbon-conductive material composite of the present invention as an electrode. Compared with an electricity storage device constructed using an electrode obtained by simply mixing the polymer radical material, the activated carbon and the conductive material, an electricity storage device constructed using an electrode that employs the polymer radical material-activated carbon-conductive material composite of the present invention exhibits a greater discharge capacity, and is capable of discharging a large electric current for several seconds.

A second electricity storage device of the present invention uses, as an electrode, a mixture of an activated carbon, and a polymer radical material-conductive material composite that is prepared by adding dropwise, or pouring, a raw material solution, in which a polymer radical material having a radical partial structure in a reduced state is dissolved or swollen and a conductive material is dispersed or dissolved, into a solution in which the polymer radical material and the conductive material do not dissolve or swell, thus obtaining a precipitate containing the polymer radical material and the conductive material.

As described above, in the polymer radical material-conductive material composite used in the present invention, the conductive material is dispersed uniformly within the polymer radical material. Accordingly, an electrode prepared by mixing this polymer radical material-conductive material composite and an activated carbon exhibits a greater discharge capacity than an electrode obtained by simply mixing the activated carbon with the polymer radical material and the conductive material that constitute the composite. As a result, the obtained polymer radical material-conductive material composite can be imparted with favorable electron conductivity. Accordingly, an electrode produced from a mixture of the polymer radical material-conductive material composite and an activated carbon exhibits a greater discharge capacity than an electrode obtained by simply mixing the polymer radical material, the activated carbon and the conductive material. Further, because the transfer of electrons that accompanies the oxidation and reduction of the polymer radical material can occur smoothly via the conductive material, charging and discharging at a large electric current is possible. Furthermore, a large electric current can be discharged for several seconds.

Accordingly, compared with an electricity storage device constructed using an electrode obtained by simply mixing the polymer radical material, the conductive material and the activated carbon, an electricity storage device constructed using an electrode that employs a mixture of the above-mentioned polymer radical material-conductive material composite and the activated carbon exhibits a greater discharge capacity, and is capable of discharging a large electric current for several seconds.

In this manner, the electricity storage device of the present invention uses either the polymer radical material-activated carbon-conductive material composite described above as an electrode (the first electricity storage device), or a mixture of the polymer radical material-conductive material composite described above and an activated carbon as the electrode (the second electricity storage device). The polymer radical material-activated carbon-conductive material composite, the polymer radical material-conductive material composite, and the production methods for these composites are as described above, and in order to avoid repetition, description of these items is omitted here.

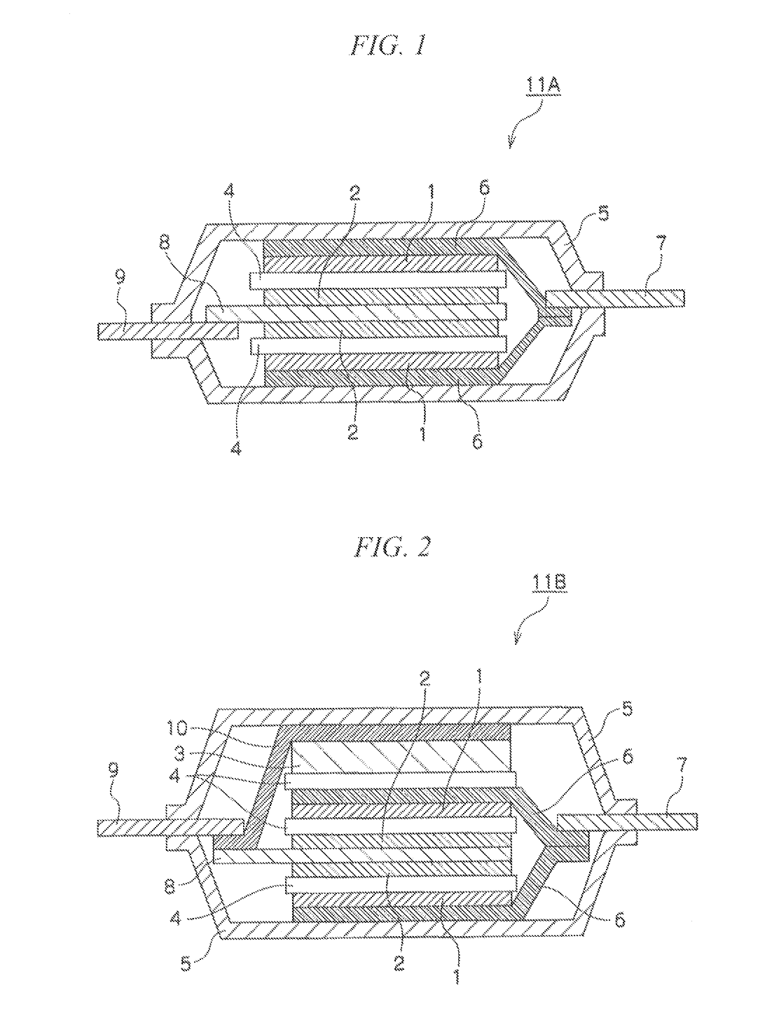

FIG. 1 is a schematic cross-sectional view of one example of an electricity storage device. This electricity storage device 11A includes a positive electrode 1, which is constructed using the polymer radical material-activated carbon-conductive material composite or a mixture of the polymer radical material-conductive material composite and an activated carbon as the main component, a positive electrode current collector 6 that is connected to the positive electrode 1, a positive electrode lead 7 that is connected to the positive electrode current collector 6 and extracts energy to a point outside the cell, a negative electrode 2 containing mainly a material capable of reversibly supporting lithium ions or metallic lithium, a negative electrode current collector 8 that is connected to the negative electrode 2, a negative electrode lead 9 that is connected to the negative electrode current collector 8 and extracts energy to a point outside the cell, a separator 4 that is interposed between the positive electrode 1 and the negative electrode 2 and conducts only ions without conducting electrons, and an external casing 5 inside which these components are sealed.

FIG. 2 is schematic cross-sectional view of another example of an electricity storage device. This electricity storage device 11B has a similar structure to the electricity storage device 11A, but is further provided with a lithium ion supply source 3 for pre-doping the negative electrode 2, and a lithium ion supply source current collector 10 that is connected to the lithium ion supply source 3.

In the electricity storage devices 11A and 11B, the external shape is determined by the external casing 5 used to house the components, but the electricity storage device is not limited to this particular shape, and any conventional shape may be used. Examples of possible shapes for the electricity storage device include shapes in which a stacked electrode assembly or wound electrode assembly is sealed inside a metal case, a resin case, or a laminated film formed from a metal foil such as aluminum foil and a synthetic resin film, and the exterior shape of the device may be cylindrical, square, coin-shaped or sheet-like.

In the electricity storage devices 11A and 11B, the basic structure is formed by stacking the positive electrode 1 provided on the positive electrode current collector 6 and the negative electrode 2 provided on the negative electrode current collector 8 so that the electrodes face each other across the separator 4 containing the electrolyte. In the present invention, within this type of basic structure, the polymer radical material-activated carbon-conductive material composite or the mixture of the polymer radical material-conductive material composite and an activated carbon according to the present invention is used as the electrode material for the positive electrode 1, the negative electrode 2, or for both electrodes.

As illustrated in the electricity storage devices 11A and 11B, an electricity storage device refers to a device having at least the positive electrode 1 and the negative electrode 2, in which an electrochemically stored energy can be extracted as electric power. In the electricity storage device, the positive electrode 1 is the electrode having a high oxidation-reduction potential, whereas the negative electrode 2 is the electrode having a low oxidation-reduction potential. Each of the structural components of the electricity storage device is described below.

### (Positive Electrode)

The polymer radical material described above has a comparatively high oxidation-reduction potential. Accordingly, it is preferable to use the polymer radical material as the active material for the positive electrode. In other words, the electrode that uses the polymer radical material-activated carbon-conductive material composite or the mixture of the polymer radical material-conductive material composite and an activated carbon according to the present invention is preferably used as the positive electrode 1.

In the positive electrode 1, other conductive materials may be added to the polymer radical material-activated carbon-conductive material composite or the mixture of the polymer radical material-conductive material composite and the activated carbon. Examples of these other conductive materials include metal oxide particles of copper, iron, gold, platinum or nickel or the like, carbon materials and conductive polymers. Specific examples of the carbon materials include the same materials as those mentioned above, namely natural graphite, artificial graphite, carbon black, vapor-grown carbon fiber, mesophase pitch carbon fiber, and carbon nanotubes. Specific examples of the conductive polymers include polyacetylene, polyphenylene, polyaniline and polypyrrole. Further, these other conductive materials may be used individually or in combination.

In order to ensure favorable mechanical properties for the positive electrode, the positive electrode 1 may also include a binder. Examples of this type of binder include polyvinylidene fluoride, polytetrafluoroethylene, vinylidene fluoride-hexafluoropropylene copolymers, vinylidene fluoride-tetrafluoroethylene copolymers, styrene-butadiene copolymer rubbers, as well as polypropylene, polyethylene, polyimide, partially carboxylated cellulose, and various polyurethanes.

Conventional methods may be used as the method for producing the positive electrode 1. For example, in one such method, a solvent is added to the polymer radical material-activated carbon-conductive material composite or the mixture of the polymer radical material-conductive material composite and the activated carbon according to the present invention to form a slurry, and this slurry is then applied to the positive electrode current collector 6. Further, in order to strengthen the binding between the component materials during preparation of the slurry, a binder may also be added. The types of binder mentioned above may be used as this binder.

### (Negative Electrode)

A material capable of reversibly supporting lithium ions is preferably used as the negative electrode 2. In other words, the electrode using the polymer radical material-activated carbon-conductive material composite or the mixture of the polymer radical material-conductive material composite and the activated carbon according to the present invention is preferably used as the positive electrode 1, and a material that is capable of reversibly supporting lithium ions is preferably used as the negative electrode 2.

Examples of the material capable of reversibly supporting lithium ions include metallic lithium, lithium alloys, carbon materials, conductive polymers and lithium oxides. Specific examples of the lithium alloys include lithium-aluminum alloys, lithium-tin alloys and lithium-silicon alloys. Specific examples of the carbon materials include graphite, hard carbon and activated carbon. Specific examples of the conductive polymers include polyacene, polyacetylene, polyphenylene, polyaniline and polypyrrole. Specific examples of the lithium oxides include lithium alloys such as lithium-aluminum alloys and lithium titanate.

There are no particular limitations on the form of the negative electrode 2, and for example in the case of lithium metal, the electrode is not limited to a thin film, and may also have a bulky form, or be in the form of a solidified powder, a fibrous form or a flaked form. Further, the above active materials for the negative electrode may be used individually or in combination. Furthermore, a conductivity imparting agent or a binder may also be added.

Examples of the conductivity imparting agent include carbon materials such as carbon black, acetylene black and carbon fiber, and metal powders. In order to strengthen the binding between the component materials of the negative electrode, a binder may also be added. Examples of the binder include polytetrafluoroethylene, polyvinylidene fluoride, vinylidene fluoride-hexafluoropropylene copolymers, vinylidene fluoride-tetrafluoroethylene copolymers, styrene-butadiene copolymer rubbers, as well as polypropylene, polyethylene, polyimide, partially carboxylated cellulose, and various polyurethanes.

### (Current Collectors)

As the positive electrode current collector 6 and the negative electrode current collector 8, nickel, aluminum, copper, gold, silver, an aluminum alloy, stainless steel or carbon or the like can be used in the form of a foil, a metal plate or a mesh. Particularly in those cases where the negative electrode 2 is pre-doped with lithium ions, the current collector preferably includes holes that penetrate through the front and rear surfaces of the current collector, such as an expanded metal, a punched metal, a metal mesh, a foamed body, or a porous foil in which etching has been used to form through-holes within the foil. The positive electrode current collector 6 and the negative electrode current collector 8 may also by imparted with a catalytic effect.

### (Separator)

A porous film foamed from polyethylene or polypropylene or the like, a cellulose film or a nonwoven fabric or the like may be used as the separator 4. In those cases where a solid electrolyte or a gel electrolyte is used as the electrolyte, a configuration in which the electrolyte is interposed between the positive electrode 1 and the negative electrode 2 may be used instead of the separator 4.

### (Electrolyte)

The electrolyte transports charge carriers between the positive electrode 1 and the negative electrode 2, and it is generally preferable that the electrolyte has an ion conductivity at 20° C. of 10⁻⁵ to 10⁻¹ S/cm. An electrolyte solution prepared by dissolving an electrolyte salt in a solvent may be used as the electrolyte, and the use of an aprotic organic solvent containing a lithium salt as the electrolyte is preferred.

Conventional materials may be used as the electrolyte salt, including LiPF₆, LiClO₄, LiBF₄, LiCF₃SO₃, Li(CF₃SO₂)₂N, Li(C₂F₅SO₂)₂N, Li(CF₃SO₂)₃C and Li(C₂F₅SO₂)₃C.

In those cases where a solvent is used in the electrolyte, examples of organic solvents that may be used as the solvent include ethylene carbonate (EC), propylene carbonate, dimethyl carbonate, diethyl carbonate (DEC), methyl ethyl carbonate, γ-butyrolactone, tetrahydrofuran, dioxolane, sulfolane, dimethylformamide, dimethylacetamide, and N-methyl-2-pyrrolidone. These solvents may be used individually or in mixtures containing two or more different solvents.

Moreover, a solid electrolyte may also be used as the electrolyte. Examples of polymers compounds that may be used in the solid electrolyte include vinylidene fluoride-based compounds such as polyvinylidene fluoride, vinylidene fluoride-hexafluoropropylene copolymers, vinylidene fluoride-ethylene copolymers, vinylidene fluoride-monofluoroethylene copolymers, vinylidene fluoride-trifluoroethylene copolymers, vinylidene fluoride-tetrafluoroethylene copolymers and vinylidene fluoride-hexafluoropropylene-tetrafluoroethylene terpolymers, acrylonitrile-based compounds such as acrylonitrile-methyl methacrylate copolymers, acrylonitrile-methyl acrylate copolymers, acrylonitrile-ethyl methacrylate copolymers, acrylonitrile-ethyl acrylate copolymers, acrylonitrile-methacrylic acid copolymers, acrylonitrile-acrylic acid copolymers and acrylonitrile-vinyl acetate copolymers, as well as polyethylene oxide, ethylene oxide-propylene oxide copolymers and acrylate or methacrylate compounds thereof. A gel prepared by incorporating an electrolyte solution within one of these polymer compounds may be used, or the polymer compound may be used alone.

### (Lithium Ion Supply Source and Current Collector Thereof)

The electricity storage device of the present invention preferably also includes a lithium ion supply source, wherein the positive electrode and/or the negative electrode is provided with a current collector having holes that penetrate through the front and rear surfaces of the current collector, and the current collector is preferably pre-doped with lithium ions via an electrochemical contact between the negative electrode and the lithium ion supply source. The electricity storage device 11B illustrated in FIG. 2 is an example of this type of electricity storage device.

The lithium ion supply source 3 in the electricity storage device 11B has the function of acting as a supply source for pre-doping the negative electrode 2 with lithium ions. Examples of the materials for the lithium ion supply source 3 include lithium metal and lithium-aluminum alloys, and lithium is particularly desirable. Examples of the material of the lithium ion supply source current collector 10 that is provided in contact with the lithium ion supply source 3 include copper, nickel and stainless steel. The lithium ion supply source current collector 10 may be in the form of a foil, a flat plate or a mesh or the like.

### (Method for Producing Electricity Storage Device)

There are no particular limitations on the method used for producing the electricity storage devices 11A and 11B, and an appropriate method may be selected in accordance with the materials being used. For example, the electricity storage device may be produced by stacking the positive electrode 1 and the negative electrode 2 with the separator 4 interposed therebetween, subsequently encasing the stacked structure inside the external casing 5, and then injecting the electrolyte into the external casing and sealing the entire structure. Further, although not shown in FIG. 1 and FIG. 2, the electricity storage device may also be produced using a method that includes winding a long positive electrode and a long negative electrode with a separator disposed therebetween, subsequently encasing the wound structure inside an external casing, and then injecting the electrolyte into the external casing and sealing the entire structure.

In the electricity storage devices 11A and 11B, other production conditions such as extraction of the positive electrode lead 7 and the negative electrode lead 9, and formation of the external casing 5 and the like may employ conventional techniques typically used in the production of batteries.

As described above, in the electricity storage device of the present invention, because the polymer radical material-activated carbon-conductive material composite or the mixture of the polymer radical material-conductive material composite and the activated carbon according to the present invention, which exhibits favorable electron conductivity, is used as an electrode, the discharge capacity increases, and a large electric current can be discharged for several seconds.

### EXAMPLES

The present invention is described in further detail below using a series of examples, but the present invention is in no way limited by these examples.

### Example 1

### <Production of a Polymer Radical Material (Nitroxyl Polymer Compound)-Activated Carbon-Conductive Material Composite>

12.0 g of a nitroxyl polymer compound of the above chemical formula (4) in which R₁ to R₅ were all methyl groups (weight-average molecular weight: 28,000) was dissolved in 12 ml of N-methylpyrrolidone. To this solution was added 2.0 g of an activated carbon (product name: YP, manufactured by Kuraray Chemical Co., Ltd.) and 5.0 g of a carbon material (product name: VGCF-H, manufactured by Showa Denko K.K., a highly crystalline carbon fiber synthesized by a vapor phase method, fiber diameter: 25-150 nm, fiber length: 10 to 20 μm, aspect ratio: 10 to 50), and the resulting mixture was stirred using a homogenizer, thus yielding a slurry in which the conductive material was uniformly dispersed.

Subsequently, this slurry was added gradually to 1 L of methanol under constant stirring, thereby precipitating a nitroxyl polymer compound-activated carbon-carbon material composite. The precipitate was filtered and then vacuum dried for 8 hours at 60° C. in a vacuum dryer, thus yielding a solid of the nitroxyl polymer compound-activated carbon-carbon material composite. This solid was ground in a mortar to form a powder.

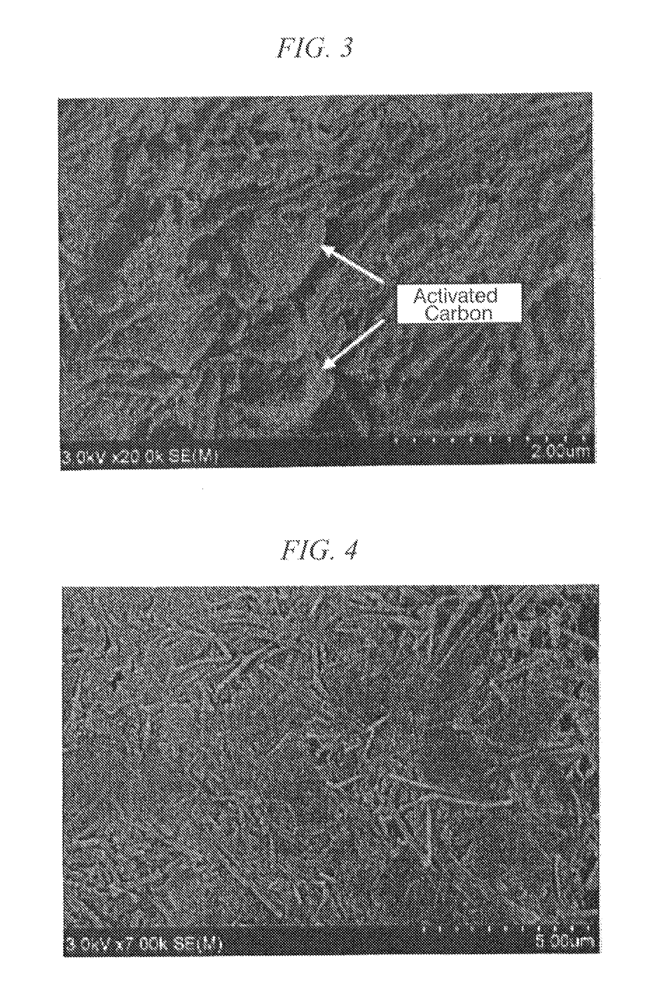

FIG. 3 is an electron microscope photograph of the nitroxyl polymer compound-activated carbon-carbon material composite. It is evident that the activated carbon and the carbon fiber have been incorporated within the interior of the nitroxyl polymer compound.

### <Production of Positive Electrode>

A mixture of 9.5 g of the nitroxyl polymer compound-activated carbon-carbon material composite obtained in the manner described above, 400 mg of carboxymethyl cellulose (CMC), 100 mg of polytetrafluoroethylene (PTFE) and 30 ml of water was stirred in a homogenizer to prepare a uniform paste. This paste was applied to an aluminum foil that was used as the positive electrode current collector, and was then dried at 100° C. for 10 minutes, thus forming a positive electrode having a thickness of 100 μm. No warping or cracking was visible on the thus obtained electrode.

### <Production of Electricity Storage Device>

In a dry room having a dew point of −50° C. or lower, the positive electrode prepared in the manner described above, and a copper foil (the negative electrode current collector) having a metallic lithium foil (the negative electrode) bonded to both surfaces were stacked in sequence with a separator disposed therebetween, thus producing an electrode assembly. A positive electrode lead was connected to the aluminum foil of the positive electrode current collector by ultrasonic welding, and a negative electrode lead was welded to the copper foil of the negative electrode current collector in a similar manner. The structure was then covered with an aluminum laminate film (the external casing) of thickness 115 μm, and three sides including the lead portions were heat sealed. Subsequently, a mixed electrolyte solution (in which EC/DEC=3/7) containing 1 mol/L of LiPF₆ was injected into the cell, and impregnated thoroughly into the electrodes. Finally, the fourth side of the external casing was heat sealed under reduced pressure, completing production of an electricity storage device (having the same configuration as the electricity storage device 11A illustrated in FIG. 1).

### <Discharge Testing>

Following production of the electricity storage device, the device was charged to 4.2 V at a constant current of 1 mA, and was then discharged to 3.0 V. The device was then charged again to 4.2 V at 0.5 mA, and then discharged to 3 V at 10 mA (equivalent to 0.5 mA/cm² per unit of surface area of the positive electrode), and the cell capacity at this time was measured. The cell capacity was 8.2 mAh (0.41 mAh/cm² per unit of surface area of the positive electrode). The device was then charged again for 5 hours at 1 mA, and subsequently discharged at 1,000 mA (50 mA/cm² per unit of surface area of the positive electrode) for 2 seconds. The voltage following the 2-second discharge was 3.0 V.

### Example 2

### <Production of a Polymer Radical Material (Nitroxyl Polymer Compound)-Conductive Material Composite>

12.0 g of a nitroxyl polymer compound of the above chemical formula (4) in which R₁ to R₅ were all methyl groups (weight-average molecular weight: 28,000) was dissolved in 12 ml of N-methylpyrrolidone. To this solution was added 5.0 g of a carbon material (product name: VGCF-H, manufactured by Showa Denko K.K.), and the resulting mixture was stirred using a homogenizer, thus yielding a slurry in which the conductive material was uniformly dispersed.

Subsequently, this slurry was added gradually to 1 L of methanol under constant stirring, thereby precipitating a nitroxyl polymer compound-carbon material composite. The precipitate was filtered and then vacuum dried for 8 hours at 60° C. in a vacuum dryer, thus yielding a solid of the nitroxyl polymer compound-carbon material composite. This solid was ground in a mortar to form a powder.

FIG. 4 is an electron microscope photograph of the nitroxyl polymer compound-carbon material composite. It is evident that the carbon fiber has been incorporated within the interior of the nitroxyl polymer compound.

### <Production of Positive Electrode>

A mixture of 8.5 g of the nitroxyl polymer compound-carbon material composite obtained in the manner described above, 1.0 g of an activated carbon (product name: YP, manufactured by Kuraray Chemical Co., Ltd.), 400 mg of carboxymethyl cellulose (CMC), 100 mg of polytetrafluoroethylene (PTFE) and 30 ml of water was stirred in a homogenizer to prepare a uniform paste. This paste was applied to an aluminum foil that was used as the positive electrode current collector, and was then dried at 100° C. for 10 minutes, thus forming a positive electrode having a thickness of 100 μm. No warping or cracking was visible on the thus obtained electrode.

### <Production of Negative Electrode>

13.5 g of a graphite powder (particle size: 6 μm), 1.35 g of polyvinylidene fluoride, 0.15 g of carbon black, and 30 g of N-methylpyrrolidone solvent were mixed thoroughly to produce a negative electrode slurry. The negative electrode slurry was applied to both surfaces of an expanded metal copper foil of thickness 32 μm that had been coated with a carbon-based conductive coating, and was then vacuum dried to complete production of a negative electrode.

In a dry room having a dew point of −50° C. or lower, the positive electrode and the negative electrode prepared using the respective methods described above were stacked in sequence with a separator disposed therebetween, and then a lithium metal-bonded copper foil that functioned as a lithium ion supply source was positioned on top of the electrode assembly. A positive electrode lead was connected to the aluminum foil of the positive electrode current collector by ultrasonic welding, and a negative electrode lead was welded to the copper foil of the negative electrode current collector in a similar manner. The structure was then covered with an aluminum laminate film (the external casing) of thickness 115 μm, and three sides including the lead portions were heat sealed. Subsequently, a mixed electrolyte solution (in which EC/DEC=3/7) containing 1 mol/L of LiPF₆ was injected into the cell, and impregnated thoroughly into the electrodes. Finally, the fourth side of the external casing was heat sealed under reduced pressure, completing production of an electricity storage device (having the same configuration as the electricity storage device 11B illustrated in FIG. 2).

### <Discharge Testing>

Following production of the electricity storage device, the device was charged to 4.2 V at a constant current of 1 mA, and was then discharged to 3.0 V. The device was then charged again to 4.2 V at 0.5 mA, and then discharged to 3 V at 10 mA (equivalent to 0.5 mA/cm² per unit of surface area of the positive electrode), and the cell capacity at this time was measured. The cell capacity was 9.2 mAh (0.46 mAh/cm² per unit of surface area of the positive electrode). The device was then charged again for 5 hours at 1 mA, and subsequently discharged at 1,000 mA (50 mA/cm² per unit of surface area of the positive electrode) for 2 seconds. The voltage following the 2-second discharge was 3.0 V.

### Comparative Example 1

### <Production of Positive Electrode>

A mixture of 6.0 g of a nitroxyl polymer compound of the above chemical formula (4) in which R₁ to R₅ were all methyl groups (weight-average molecular weight: 28,000), 1.0 g of an activated carbon (product name: YP, manufactured by Kuraray Chemical Co., Ltd.), 2.5 g of a carbon material (product name: VGCF-H, manufactured by Showa Denko K.K.), 400 mg of carboxymethyl cellulose (CMC), 100 mg of polytetrafluoroethylene (PTFE) and 30 ml of water was stirred in a homogenizer to prepare a uniform paste. This paste was applied to an aluminum foil that was used as the positive electrode current collector, and was then dried at 100° C. for 10 minutes, thus forming a positive electrode having a thickness of 100 μm. No cracking was visible on the thus obtained electrode. The electrode exhibited slight warping, but was still able to be used in the production of an electricity storage device.

### <Production of Electricity Storage Device>

With the exception of using the positive electrode produced in the above manner, an electricity storage device was produced in the same manner, and with the same configuration, as Example 1.

### <Discharge Testing>

Following production of the electricity storage device, the device was charged to 4.2 V at a constant current of 1.0 mA, and was then discharged to 3.0 V. The device was then charged again to 4.2 V at 1.0 mA, and then discharged to 3 V at 10 mA (equivalent to 0.5 mA/cm² per unit of surface area of the positive electrode), and the cell capacity at this time was measured. The cell capacity was 5.8 mAh (0.29 mAh/cm² per unit of surface area of the positive electrode). The device was then charged again for 4 hours at 1 mA, and subsequently discharged at 1,000 mA (50 mA/cm² per unit of surface area of the positive electrode) for 3 seconds. The voltage following the 3-second discharge was 2.0 V or less.

### Comparative Example 2

### <Production of Electricity Storage Device>

With the exception of using the positive electrode produced in Comparative Example 1, an electricity storage device was produced in the same manner, and with the same configuration, as Example 2.

### <Discharge Testing>

Following production of the electricity storage device, the device was charged to 4.2 V at a constant current of 1.0 mA, and was then discharged to 3.0 V. The device was then charged again to 4.2 V at 1.0 mA, and then discharged to 3 V at 10 mA (equivalent to 0.5 mA/cm² per unit of surface area of the positive electrode), and the cell capacity at this time was measured. The cell capacity was 7.0 mAh (0.35 mAh/cm² per unit of surface area of the positive electrode). The device was then charged again for 4 hours at 1 mA, and subsequently discharged at 1,000 mA (50 mA/cm² per unit of surface area of the positive electrode) for 3 seconds. The voltage following the 3-second discharge was 2.0 V or less.

The above results confirmed that the electricity storage devices that used either the polymer radical material-activated carbon-conductive material composite of the present invention or a mixture of the polymer radical material-conductive material composite of the present invention and an activated carbon, exhibited a larger discharge capacity and underwent a smaller voltage drop when a large current was discharged than the electricity storage devices that did not use a composite.

### INDUSTRIAL APPLICABILITY

An electricity storage device according to the present invention is capable of achieving both high energy density and high output characteristics, and can therefore be used as a power source for all manner of portable electronic devices that require high output, as a stored power source for driving an electric vehicle or hybrid vehicle or an auxiliary power source for such vehicles, as an electricity storage device for various energy sources such as solar energy or wind power generation, or as a stored power source for various household electrical appliances.

### DESCRIPTION OF THE REFERENCE SIGNS

1 Positive electrode
2 Negative electrode
3 Lithium ion supply source
4 Separator
5 External casing
6 Positive electrode current collector
7 Positive electrode lead
8 Negative electrode current collector
9 Negative electrode lead
10 Lithium ion supply source current collector
11 (11A, 11B) Electricity storage device

1. A method for producing a polymer radical material-activated carbon-conductive material composite, the method comprising:
adding dropwise, or pouring, a raw material solution, in which a polymer radical material having a radical partial structure in a reduced state is dissolved or swollen and an activated carbon and a conductive material are dispersed or dissolved, into a solution in which the polymer radical material, the activated carbon and the conductive material do not dissolve or swell, thereby producing a precipitate comprising the polymer radical material, the activated carbon and the conductive material.

2. The method for producing a polymer radical material-activated carbon-conductive material composite according to claim 1, wherein the polymer radical material is a nitroxyl polymer compound having a nitroxyl cation partial structure represented by chemical formula (1) shown below in an oxidized state, and having a nitroxyl radical partial structure represented by chemical formula (2) shown below in a reduced state.

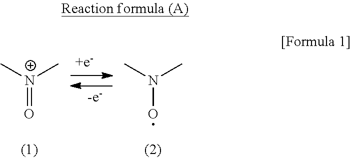

3. The method for producing a polymer radical material-activated carbon-conductive material composite according to claim 2, wherein the nitroxyl polymer compound is a polymer compound comprising a cyclic nitroxyl structure represented by chemical formula (3) shown below in a reduced state: 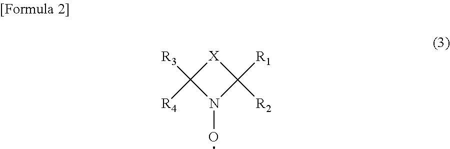
wherein each of R₁ to R₄ independently represents an alkyl group, and X represents a divalent group that results in formation of a 5- to 7-membered ring within the chemical formula (3), provided that at least a portion of X constitutes a portion of a main chain of the polymer compound.

4. The method for producing a polymer radical material-activated carbon-conductive material composite according to claim 1, wherein the polymer radical material is a polymer compound having a chemical structure represented by chemical formula (4) and/or chemical formula (5) shown below, or a copolymer that comprises the chemical structure as a repeating unit: 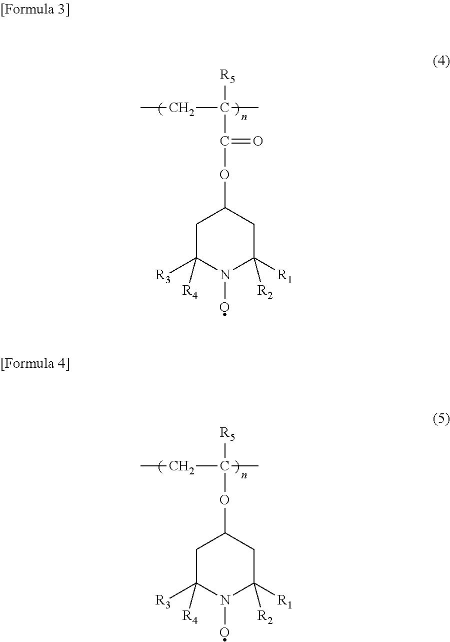
wherein each of R₁ to R₄ independently represents an alkyl group, and R₅ represents a hydrogen atom or a methyl group.

5. A polymer radical material-activated carbon-conductive material composite, prepared by adding dropwise, or pouring, a raw material solution, in which a polymer radical material having a radical partial structure in a reduced state is dissolved or swollen and an activated carbon and a conductive material are dispersed or dissolved, into a solution in which the polymer radical material, the activated carbon and the conductive material do not dissolve or swell, thus obtaining a precipitate in which the activated carbon and the conductive material are incorporated within an interior of the polymer radical material.

6. The polymer radical material-activated carbon-conductive material composite according to claim 5, wherein the polymer radical material is a nitroxyl polymer compound having a nitroxyl cation partial structure represented by chemical formula (1) shown below in an oxidized state, and having a nitroxyl radical partial structure represented by chemical formula (2) shown below in a reduced state.

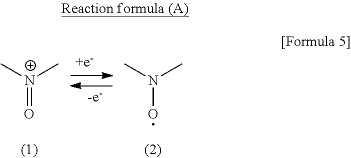

7. The polymer radical material-activated carbon-conductive material composite according to claim 6, wherein the nitroxyl polymer compound is a polymer compound comprising a cyclic nitroxyl structure represented by chemical formula (3) shown below in a reduced state: 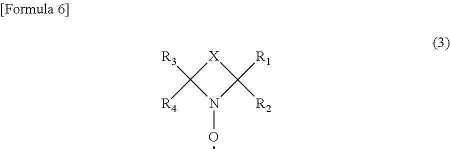
wherein each of R₁ to R₄ independently represents an alkyl group, and X represents a divalent group that results in formation of a 5- to 7-membered ring within the chemical formula (3), provided that at least a portion of X constitutes a portion of a main chain of the polymer compound.

8. The polymer radical material-activated carbon-conductive material composite according to claim 5, wherein the polymer radical material is a polymer compound having a chemical structure represented by chemical formula (4) and/or chemical formula (5) shown below, or a copolymer that comprises the chemical structure as a repeating unit: 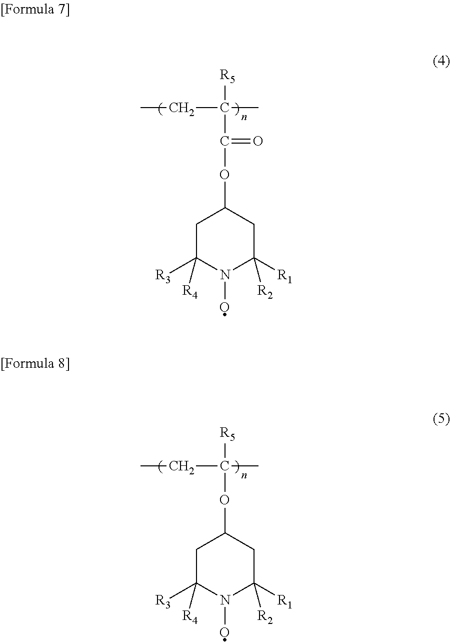
wherein each of R₁ to R₄ independently represents an alkyl group, and R₅ represents a hydrogen atom or a methyl group.

9. The polymer radical material-activated carbon-conductive material composite according to claim 5, wherein the conductive material is at least one material selected from the group consisting of natural graphite, artificial graphite, carbon black, vapor-grown carbon fiber, mesophase pitch carbon fiber, and carbon nanotubes.

10. The polymer radical material-activated carbon-conductive material composite according to claim 5, wherein the activated carbon is in a particulate form and has a specific surface area of at least 1,000 m²/g.

11. The polymer radical material-activated carbon-conductive material composite according to claim 5, wherein the activated carbon is in a particulate form, and is at least one activated carbon selected from the group consisting of phenolic resin-based activated carbon, petroleum pitch-based activated carbon, petroleum coke-based activated carbon, and coal coke-based activated carbon.

12. An electricity storage device, which uses the polymer radical material-activated carbon-conductive material composite according to claim 5 as an electrode.

13. An electricity storage device, which uses, as an electrode, a mixture of an activated carbon, and a polymer radical material-conductive material composite that is prepared by adding dropwise, or pouring, a raw material solution, in which a polymer radical material having a radical partial structure in a reduced state is dissolved or swollen and a conductive material is dispersed or dissolved, into a solution in which the polymer radical material and the conductive material do not dissolve or swell, thus obtaining a precipitate comprising the polymer radical material and the conductive material.

14. The electricity storage device according to claim 13, wherein the polymer radical material is a nitroxyl polymer compound having a nitroxyl cation partial structure represented by chemical formula (1) shown below in an oxidized state, and having a nitroxyl radical partial structure represented by chemical formula (2) shown below in a reduced state.

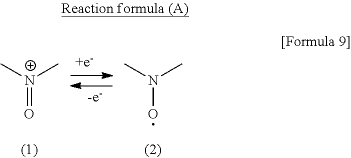

15. The electricity storage device according to claim 14, wherein the nitroxyl polymer compound is a polymer compound comprising a cyclic nitroxyl structure represented by chemical formula (3) shown below in a reduced state: 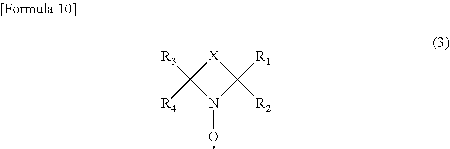
wherein each of R₁ to R₄ independently represents an alkyl group, and X represents a divalent group that results in formation of a 5- to 7-membered ring within the chemical formula (3), provided that at least a portion of X constitutes a portion of a main chain of the polymer compound.

16. The electricity storage device according to claim 13, wherein the polymer radical material is a polymer compound having a chemical structure represented by chemical formula (4) and/or chemical formula (5) shown below, or a copolymer that comprises the chemical structure as a repeating unit: 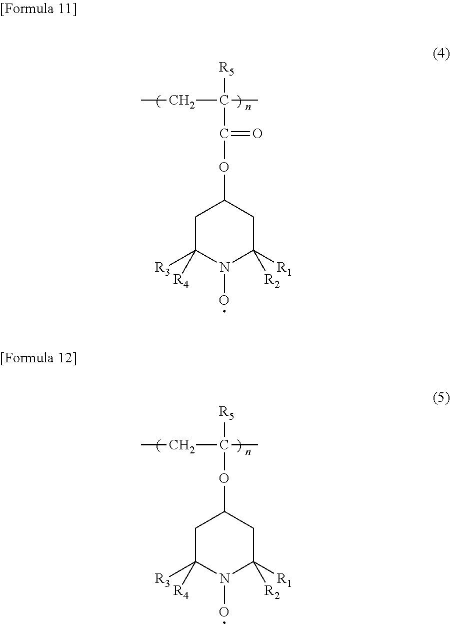
wherein each of R₁ to R₄ independently represents an alkyl group, and R₅ represents a hydrogen atom or a methyl group.

17. The electricity storage device according to claim 12, wherein the electrode is a positive electrode.

18. The electricity storage device according to claim 17, wherein the electrode is a positive electrode, a negative electrode comprises a material that can reversibly support lithium ions, and an aprotic organic solvent comprising a lithium salt is used for an electrolyte.

19. The electricity storage device according to claim 18, further comprising a lithium ion supply source, wherein the positive electrode and/or the negative electrode comprises a current collector having holes that penetrate through front and rear surfaces of the current collector, and the current collector is pre-doped with lithium ions via an electrochemical contact between the negative electrode and the lithium ion supply source.
